(19) United States
(12) Patent Application Publication
(10) Pub. No.: US 2012/0115352 A1
(43) Pub. Date: May 10, 2012

(54) MODULAR JACK WITH A PAIR OF LED DEVICES THEREON

(75) Inventor: SEN CHENG, Kunshan (CN)

(73) Assignee: HON HAI PRECISION INDUSTRY CO., LTD., New Taipei (TW)

(21) Appl. No.: 13/290,135

(22) Filed: Nov. 7, 2011

(30) Foreign Application Priority Data
Nov. 5, 2010 (CN) 201020593416.6

(51) Int. Cl. H01R 3/00; F21V 15/00

(52) U.S. Cl. 439/488; 362/362

(57) ABSTRACT

An indicator comprises a casing, a first terminal with a first end retained in the casing and a second end extending downwardly from the casing, a chip mounted on said first end and received in said casing, a second terminal also with one end retained in said casing, and conductive elements, connecting with said first and second terminals. A zener diode is also mounted on the first end of the first terminal and received in said casing, the chip and the zener diode are respectively connected with said one end of the second terminal by individual conductive elements, which can provide an ESD protection for the indicator.

### BACKGROUND OF THE INVENTION

1. Field of the Invention

The present invention relates to a LED device, and more particularly to a LED device assembled in a modular jack and which is incorporated with ESD (electrostatic discharge) protection.

2. Description of the Related Art

Electrical connectors having built-in indicator have been known for some time. In these connectors, the indicator typically are located at the front of the connector. A typical connector may include an integral LED device to emit a light which indicates an operational function such as the reception or transmission of data or voice signals, verification of a good connection between separate pieces of equipment, indication when power is on or off, indication of a defect in a network transmission or any other state or condition in the equipment with which the connector is operatively associated.

Usually, the LED device comprises a rectangular casing and a first and a second terminals retained in the casing with legs exposed to an exterior. A chip is retained within the casing and soldered onto an inner end of the first terminal. A conductive element is attached to an inner end of the second terminal and connects to the chip so as to realize an electric conduction. However, after a period usage of the LED device, lots of electrostatic charge will accumulate on the chip and damage the chip during the electrostatic discharge. Obviously, a LED device with an ESD protection is needed.

### SUMMARY OF THE INVENTION

Accordingly, an object of the present invention is to provide a LED device with an ESD protection.

In order to achieve the object set forth, an indicator comprises a casing, a first terminal with a first end retained in the casing and a second end extending downwardly from the casing, a chip mounted on said first end and received in said casing, a second terminal also with one end retained in said casing, and conductive elements, connecting with said first and second terminals. A zener diode is also mounted on the first end of the first terminal and received in said casing, the chip and the zener diode are respectively connected with said one end of the second terminal by individual conductive elements.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of an electrical connector in accordance with the present invention;

FIG. 2 is another perspective view of the electrical connector shown in FIG. 1;

FIG. 3 is an exploded perspective view of the electrical connector shown in FIG. 1;

FIG. 4 is another exploded perspective view of the electrical connector shown in FIG. 1;

FIG. 5 is a cross-sectional view of the electrical connector shown in FIG. 1 along line 5-5; and

FIG. 6 is a circuit diagram of a LED device of the electrical connector shown in FIG. 1.

### DETAILED DESCRIPTION OF THE INVENTION

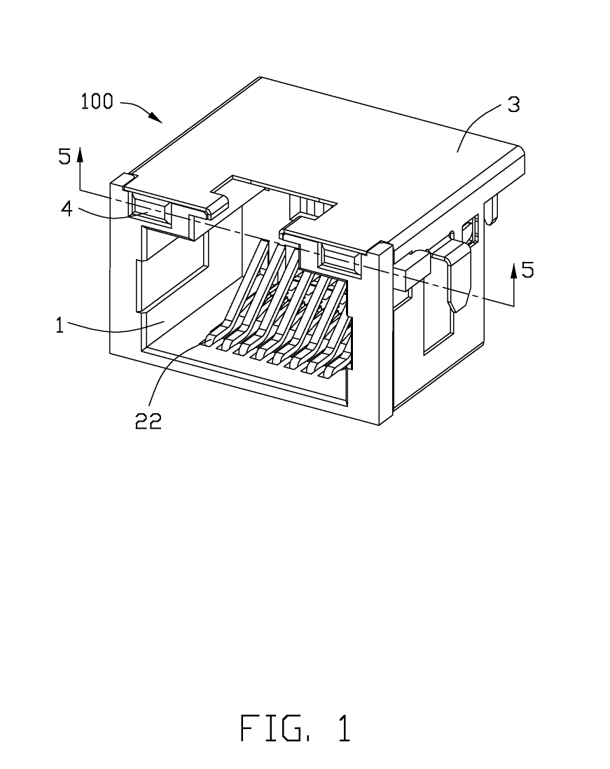

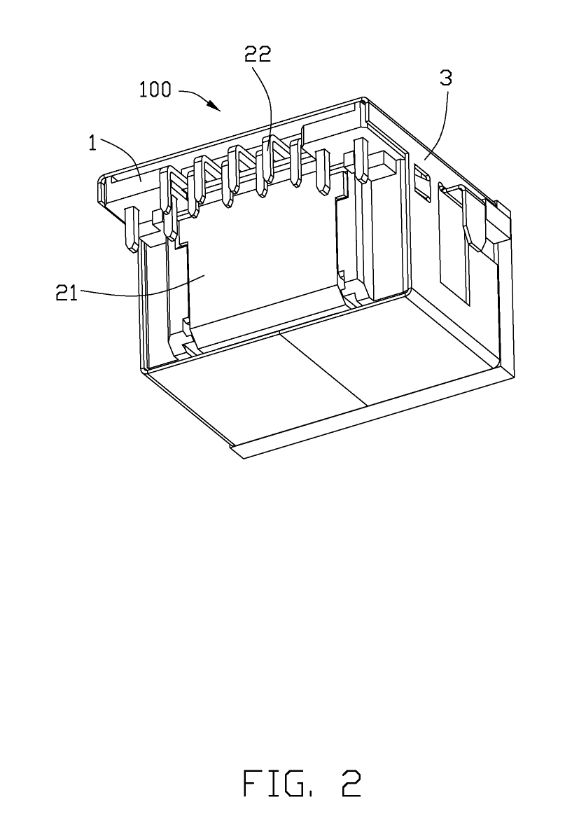

Reference will now be made to the drawing figures to describe a preferred embodiment of the present invention in detail. Referring to FIG. 1 to FIG. 3, an electrical connector 100 made according to the preferred embodiment of the present invention is provided and comprises an insulative housing 1, a terminal module 2 received in the insulative housing 1, a metallic shell 3 surrounding the insulative housing 1 and a pair of indicators (LED devices) 4 assembled on the insulative housing 1.

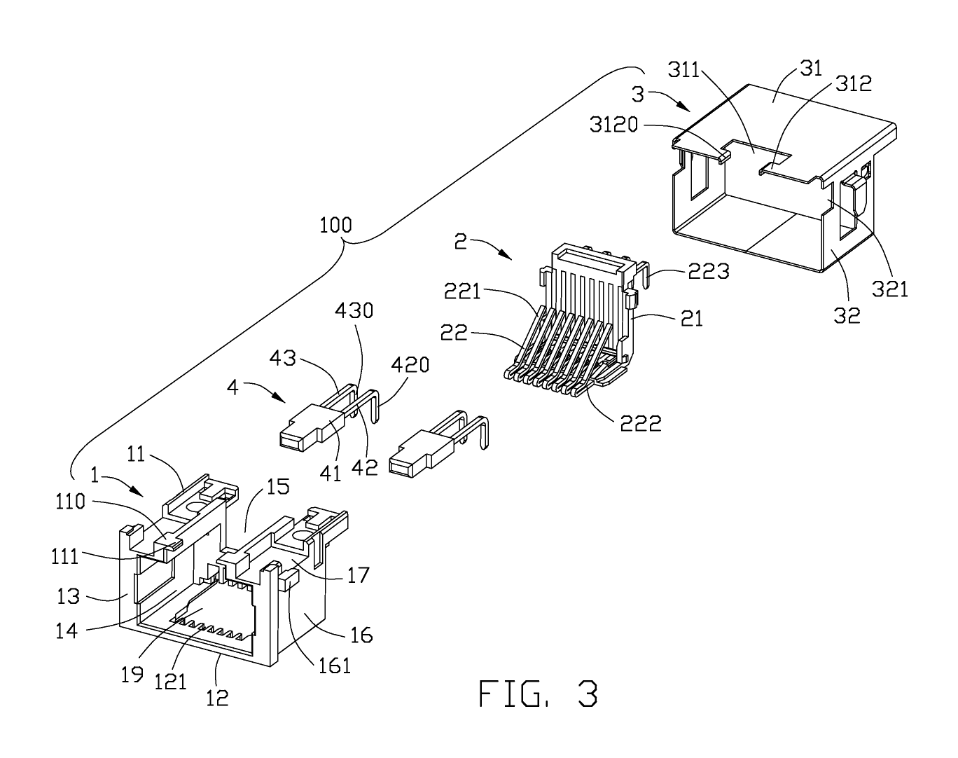

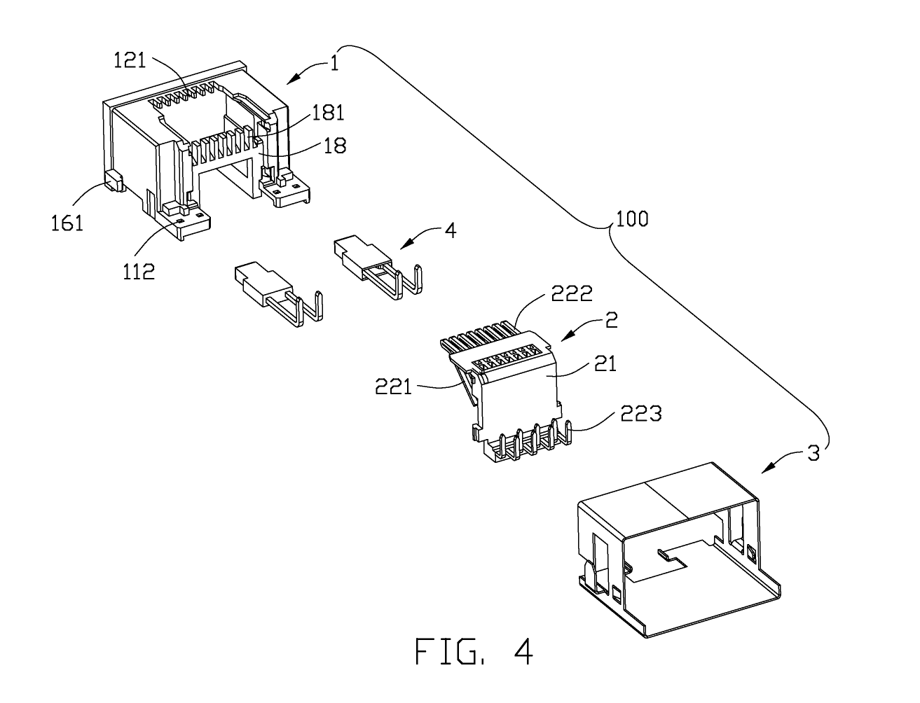

Referring to FIGS. 3 and 4, the insulative housing 1 is in a rectangular shape and comprises an upper wall 11, a lower wall 12 opposite to the upper wall 11, a front wall 13 and a pair of side walls 16 connecting with the upper wall 11 and lower wall 12. A receiving room 14 is defined in the insulative housing 1 and extends rearward from the front wall 13. An elongated channel 15 is defined at a middle portion of the upper wall 11 along a rear-to-front direction and forms a pair of blocks 110 at a front end thereof. A pair of elongated passageways 17 are defined at opposite sides of the upper wall 11 and locate beside the blocks 110 for receiving the pair of LED devices 4. A pair of through holes 112 are defined at a rear end of each passageway 17 and run through the upper wall 11 for receiving legs of the LED devices 4. Each of the blocks 110 has an inner engaging surface 111 facing to the opposite block 110. An opening 19 is defined at the lower wall 12 and communicates with the receiving room 14. A plurality of terminal grooves 121 are defined on the lower wall 12 and located between the front wall 13 and the opening 19. A plurality of positioning slots 181 are defined at a rear wall 18 and extend downwardly along a vertical direction. Further, a pair of protrusion portions 161 are formed at lateral sides of the side walls 16.

The terminal module 2 is inserted into the receiving room 14 from a rear end of the insulative housing 1. The terminal module 2 comprises an L shaped base portion 21 and a plurality of contacts 22 insert-molded in the base portion 21. The contacts 22 are received in the opening 19, each having a retaining portion 222 secured in the base portion 21 and horizontally extending forwardly until received in the terminal grooves 121, a contacting portion 221 extending rearward from a front end of the retaining portion 222 until received in the positioning slots 181, and a soldering portion 223 extending out of the insulative housing.

The metallic shell 3 is made by stamping a metal piece and comprises an upper wall 31 and a pair of side walls 32 located at opposite sides of the upper wall 31 and extending downwardly. A window 311 is defined at a front edge of the upper wall 31 and leaves a pair of strengthening plates 312 at opposite sides thereof. Each strengthening plate 312 has a buckling plate 3120 extending downwardly from a lateral edge thereof and parallel to the side walls 32. The metallic shell 3 is assembled on the insulative housing 1 with the pair of buckling plate 3120 attached to the engaging surface 111 so as to increase the strength of the blocks 110. Further, a pair of apertures 321 are respectively defined at a front edge of the side walls 32 for receiving the pair of protrusion portions 161.

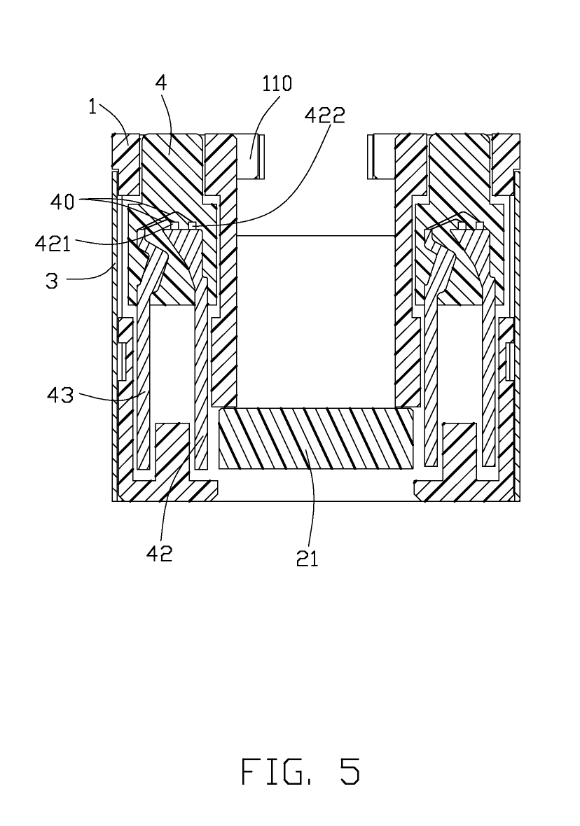

Referring to FIG. 3 to FIG. 5, the LED devices 4 are received in the passageways 17, each comprising a rectangular casing 41, a first terminal 42 and a second terminal 43 partly retained in the rectangular casing 41. At an inner end of the first terminal 42, a chip 421 which can emit light is mounted thereon by a soldering method. Beside the chip 421, a zener diode 422 is also provided and mounted on the inner end of the first terminal 42 by a soldering method. Zener diode 422 is a special kind of diode which allows current to flow in the forward direction in the same manner as an ideal diode, but will also permit it to flow in the reverse direction when the voltage is above a certain value known as the breakdown voltage. The chip 421 and the zener diode 422 are connected to an inner end of the second terminal 43 by two individual conductive elements 40.

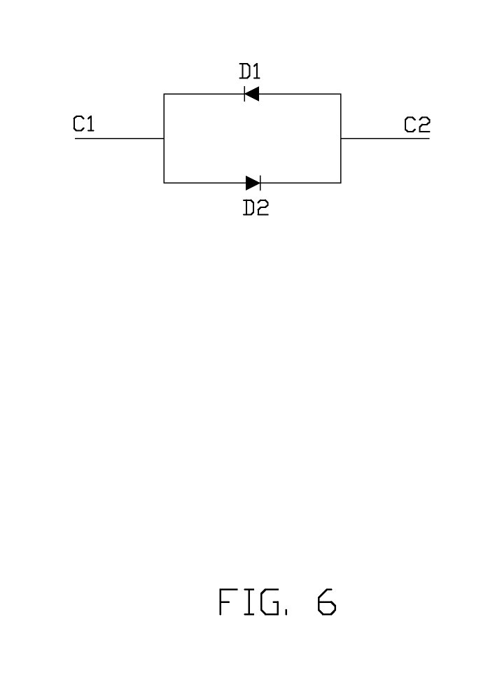

Referring to FIG. 6, which shows a circuit diagram of the LED device 4, the diode D1 stands for the chip 421, and the diode D2 stands for the zener diode 422. The diode D1 and diode D2 form an anti-parallel circuit diagram. In this case, the electrostatic charge accumulated on the diode D1 could be discharged through the diode D2, which can protect the diode D1 effectively. Two ends C1, C2 of the circuit diagram respectively connect to the first and second terminals 42, 43.

Referring to FIGS. 3 and 4, the first and second terminals 42, 43 respectively have a first leg 420 and a second leg 430 extending downwardly from the rectangular casing 41 and running through the through holes 112. The zener diode 422 assembled on the first terminal 42 can emit the electrostatic charge accumulated on the chip 421, which can prevent the chip 421 from being destroyed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An indicator comprising:
a casing;
a first terminal with a first end retained in the casing and a second end extending downwardly from the casing, a chip mounted on said first end and received in said casing;
a second terminal also with one end retained in said casing; and
conductive elements, connecting with said first and second terminals;
wherein a zener diode is also mounted on the first end of the first terminal and received in said casing, the chip and the zener diode are respectively connected with said one end of the second terminal by individual conductive elements.

2. The indicator as described in claim 1, wherein the chip and the zener diode are mounted on said first end of the first terminal by a soldering method.

3. An electrical connector comprising:
an insulative housing having an upper wall, a lower wall, and a pair of side walls connecting the upper wall and lower wall thereby defining a receiving space therebetween, a pair of passageways being defined at opposite sides of the upper wall and extending along a front-to-rear direction;
a plurality of contacts, retained on the lower wall with contacting portions projecting into the receiving space;
a pair of indicators, respectively retained in said passageways, each comprising a casing, a first and a second terminals each having one end retained in said casing, a chip and a zener diode received in said casing and respectively mounted on said one end of the first terminal;
wherein conductive elements are provided to connect said chip and zener diode to said one end of the second terminal.

4. The electrical connector as described in claim 3, wherein the pair of indicators are assembled in the passageways along a vertical direction perpendicular to said front-to-rear direction.

5. The electrical connector as described in claim 4, wherein each indicator has a pair of legs extending out of the casing and running through a pair of apertures defined at a rear end of each passageway.

6. The electrical connector as described in claim 3, wherein the upper wall is divided into two separate parts and leaves a large interval therebetween.

7. The electrical connector as described in claim 6, wherein a pair of blocks are formed on a front section of the upper wall and protrude into said interval.

8. The electrical connector as described in claim 7, wherein a metallic shell is provided to surround the insulative housing, on a front section of which a window is defined with a pair of buckling plates extending downwardly to cooperate with the blocks.

9. An electrical connector comprising:
an insulative housing defining a mating port;
a plurality of terminals disposed in the housing with contacting sections exposed in the mating port;
a pair of LED (Laser Emitting Diode) devices mounted in the housing beside the mating port, each of said LED devices including:
a casing;
first and second leads having inner ends embedded in the casing and outer ends exposed outside of the casing; and
first and second circuit paths formed between the inner ends of said first and second leads in parallel; wherein
the first path is equipped with a chip for emitting light and the second path is equipped with a zener diode for releasing overflowed current.
